(19) United States
(12) Patent Application Publication
(10) Pub. No.: US 2007/0205276 A1
(43) Pub. Date: Sep. 6, 2007

(54) Visualization confirmation of price zoning display

(76) Inventors: Uwe Sodan, Hockenheim (DE); David Ginsberg, Scottsdale, AZ (US); Kenneth Ouimet, Scottsdale, AZ (US); Ralf Rath, Mannheim (DE)

Correspondence Address: KENYON & KENYON LLP, 1500 K STREET N.W., WASHINGTON, DC, 20005, US

(21) Appl. No.: 11/595,163

(22) Filed: Nov. 8, 2006

Related U.S. Application Data
(60) Provisional application No. 60/778,435, filed on Mar. 1, 2006.

(51) Int. Cl. G06K 15/00; G07G 1/00

(52) U.S. Cl. 235/383; 705/10

(57) ABSTRACT

A method and apparatus for iterative price zone analysis includes steps of generating auxiliary data for a geographic region that includes a plurality of retail locations, the regions being dividable into a plurality of geographic zones. The method and apparatus further includes modeling of sales information for the retail locations and thereby generate demand model information based on the set zones. The method and apparatus further includes providing the demand model information and the retail locations having the demand model information associated therewith to a price zoning display of the geographic region. Additionally the auxiliary data is provided for display relative to the model information and retail locations, where the display allows for the iterative selection of various factors and recalculations of the modeling information on the visual display.

### RELATED APPLICATIONS

The present invention relates to and claims priority to the provisional patent application entitled VISUALIZATION FOR RETAIL PRIZE ZONE OPTIMIZATION having Ser. No. 60/778,435 and a filing date of Mar. 1, 2006.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to a visual interface for interactive data analysis and more specifically to interactive price zone computations using a visual interface including auxiliary data for the iterative analysis of commercial or retail data based in part on geographic regional designations.

In commercial activities, significant economic benefits can be achieved by various processing analyses of pricing and other commercial components. These analyses provide for strategic planning and optimization of the commercial activities, including for example pricing aspects for various items, including what and when items may be offered for sale.

Retailers typically operate on very narrow margins. A well-thought strategy on prices and variety of product offerings is essential to developing a business. Retailers are afforded the opportunity to strategically use customer data assets, including information about the customers and their spending habits, or they can risk losing competitive commercial ground. Practical, data-driven techniques are currently available, including known techniques for modeling retail demand, and optimizing profit, revenue and price image.

These existing systems operate by analyzing various types of data and performing various algorithms on the data. These algorithms determine, among other things, optimized pricing information, or range of prices, for various retail items corresponding to retail locations. For example, U.S. Pat. No. 7,020,617 describes a strategic planning and optimization system that may include characterizing primary goals and auxiliary goals in enterprise planning models for retail operations.

Retailers group stores into zones for a variety reasons, such as management structure, media planning, supply chain considerations, regional merchandise variations, among others. A primary driver is the need for price consistency within various defined zones. Retailers align their stores in such price zones so that stores generally have the same pricing levels and strategies. The optimal result is to then manage the fewest zones that maximize profitability, within predefined parameters of competition, advertising zones, cross-shopping exposure and various geographic considerations.

In existing systems, these zone and pricing computations are computationally done based on existing databases of information to thereupon generate non-visual results. The systems focus on processing the algorithms to generate data that can be then used by a business person to implement the business procedures. These black-box operations have limited user interactivity, beyond allowing a user to adjust input factors.

In the development of price zoning information, there can be significant advantages to a visual interface, which currently is not available. Current systems may include user interfaces for providing the computational aspects to the algorithms, such as selecting various commercial goals, for example having a primary goal of maximizing gross profits and an auxiliary goal of maintain overall price image. Other rudimentary interface aspects may include selecting the enablement of the computer-based processing of performing the algorithmic computation. Although, these current systems do not have visual interfacing, which can be beneficial when working with geographical zoning information relating to various retail sites and attendant commercial activities at these sites. The existing systems are also unable to coordinate additional information outside of the retail or commercial information, where such auxiliary data can provide additional insight beyond the specific modeling information.

### BRIEF DESCRIPTION OF THE DRAWINGS

FIG. 1 illustrates a block diagram of one embodiment of an apparatus for interactive price zoning display;

FIG. 2 illustrates a block diagram of one embodiment of the price zoning algorithm including the interactive price zone display;

FIG. 3 illustrates a sample opportunity curve generated based in part on the price zoning algorithm and presented as a part of the visual display;

FIG. 4 illustrates a sample screen shot of a visualization of price zoning information capable of being adjusting through the visual display;

FIG. 5 illustrates another sample screen shot of a visualization of a price zoning information, including various constraints in the interactive display;

FIG. 6 illustrates a plurality of sample screen shots including of price zone information with an overlay of auxiliary data;

FIG. 7 illustrates a sample screen shot including optimization results for various objective functions in an visual interactive display;

FIG. 8 illustrates another sample screen shot including price zone information with various geographic zones for various retail locations;

FIG. 9 illustrates a flowchart of the steps of one embodiment of a method for interactive price zoning display; and

FIG. 10 illustrates a flowchart of the steps of one embodiment of a method for iterative price zone analysis.

### DETAILED DESCRIPTION

Price zone optimization for retail management may include visual interaction for adjusting various modeling or other processing factors. Geographic regions may be divided into geographic zones including various retail locations. The interactive price zoning display may include accessing auxiliary data for the region, as well as modeling sales information to generate the demand model information. This demand model information may be formatted and provided for visual display on a display device. The auxiliary data may also be formatted and provided for visual display, where the display includes a geographical map or the region with the various zones. Furthermore, the display may be interactive by allowing a user to adjust the zones and thereby iteratively adjust the modeling of the sales information.

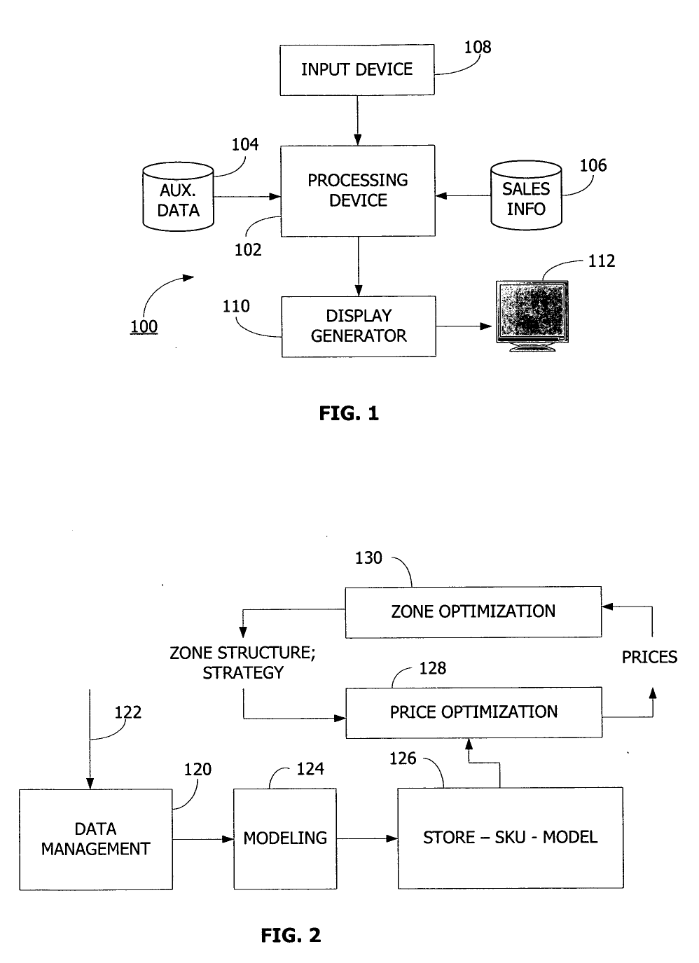

FIG. 1 illustrates one embodiment of an apparatus 100 for interactive price zoning display including a processing device 102, an auxiliary data database 104, a sales information database 106, an input device 108, a display generator 110 and a display device 112. The processing device 102 may be one or more processing devices operative to perform processing steps in response to executable instructions. While not explicitly illustrated, the executable instructions may be retrieved from one or more storage devices, where the processing device performs the processing operations in response to these executable instructions.

The auxiliary database 104 and the sales information database 106, each, may be one or more storage devices storing associated information therein. The auxiliary database 104 stores auxiliary data therein, where the auxiliary data may be additional data not included in the sales information data, such as but not limited to population density data, voting data, economic distribution data, population data, for example. The sales information database 106 stores sales information data therein, where the sales information data is data usable by the processing device to perform modeling operations as recognized by those having ordinary skill in the art.

The input device 108 may be one or more device capable of providing one or more input signals to the processing device 102. For example, the input device 108 may be a keyboard, keypad or other tactile input device. In another example, the input device 108 may be a mouse, touch screen or any other suitable type of device capable of receiving and providing the input signal to the processing device 102. The display generator 110 may be one or more processing devices operative to receive display commands or data signals capable of being displayed and providing an output signal capable of being visually displayed on the display device 112. In one embodiment, the display generator 110 may include processing steps to format or otherwise translate the output information from the processing device 102 so that it is viewable on the display device 112, for example which may include adjusting the data so that it is viewable on a map display of a geographic region.

In the apparatus 100 of FIG. 1, the processing device 102 is operative to perform processing operations in response to the executable instructions, including modeling sales information for a plurality of retail locations to thereby generate demand model information. In the executable operations, a geographic region is defined, where that region includes a plurality of retails locations. The retail locations typically represent store fronts or other locations for performing commercial activities. The geographic region is divided into numerous geographic zones, where these zones may include one or more retail locations. The division of the region into numerous zones can be manually done or in one embodiment may be randomly selected as an initial calculation point for further iterative analysis.

In addition to the modeling of the sales information, where these modeling operations are done in accordance with known modeling techniques, the processing device is also operative to generate auxiliary data for the geographic region. The processing device 102, in generating this data, may parse bundles of auxiliary information and make it usable for the display on the map of the geographic zone. The generation of the auxiliary data may also include computational or other processing steps to coordinate and apply the data to the geographic zones of the geographic region.

Upon processing this information, the processing device 102 is operative to provide the demand model information generated from the sales information to the display generator 110. The processing device 102 may also process the retail location information, as this information is based on the defined geographic zones of the geographic region. This retail location information may be included in the sales information or may be retrieved from additional data storage sources (not shown). The processing device 102 may also, upon processing the auxiliary data for the geographic region and/or geographic zones, provide the auxiliary data to the display generator 110.

The display generator 110 may thereupon format or otherwise adjust the demand model information, retail location information and the auxiliary data for display on the display device 112. As described in further detail below, the price zone display on the display device 112 may include a display of a map of the geographic region that is divided up into the various geographic zones, with the retail locations appropriately placed on the map. Additionally, the auxiliary data may also be overlaid on the map, as well as a display of the demand model information.

In further embodiments of the apparatus 100 of FIG. 1, the input device 108 may receive input commands for adjusting the geographic zones on the display. Based on the input command, the adjustment of the zones may thereupon provide for adjustment of the parameters for modeling of the sales information. For example, the input device 108 may include a pixel location recognition operation to recognize user-activated adjustments of regions or zones on the display, such as using a graphical user interface. The processing device 102 may perform additional modeling operations based on the new grouping of retail locations, as determined by the visual interface.

After the processing device performs the modeling operations on the adjusted geographic zones, the processing device 102 in conjunction with the display generator 110, provides for an adjusted price zoning display on the display device 112. This process may be iteratively performed allowing a user, through the input device 108 and the processing device 102, to perform various analysis operations using the price zone display and the interactive nature of the display.

In addition, the display generator 110 provides the auxiliary data from the auxiliary database 104 in a visual overlay on the price zoning display. This overlay provides a visual comparison of modeled price zoning information to the auxiliary information, for example if the auxiliary information relates to population density the price zoning information can be visually compared in an interactive nature to population information. The apparatus 100 illustrates the auxiliary data being retrieved from an auxiliary database 104, but it is recognized that this data may be available from any suitable source, whereby the processing device 102 allows the data to be viewable on the price zoning display.

FIG. 2 illustrates a block diagram of one embodiment for price zone optimization including the zone optimization. The approach includes performing data management operations 120 on input information 122 where the information may include store information, product information (such as stock keeping unit (SKU) information), calendar information, pricing information, promotional information, sale quantity information, among other information.

Based on the data management operations 120, the data may be modeled 124, such as building a demand model upon historical sales data, including modeling simultaneously various factors such as price, promotion, offer, assortment, seasonality, trends, holidays, product life-cycles, as well as cannibalization and affinity. The model operations 124 may thereupon provide store/SKU models 126 that are usable for price zone calculations, in accordance with known techniques.

Optimization of the price zone may include operations for optimizing the price as well as optimizing the geographic zone. Regardless of specific location, various stores may be allocated to different price zones, whereas as historically stores where geographically allocated based on the assumption that all similarly geographic shoppers are alike. A price optimization routine 128 and a zone optimization routine 130 provide for iterative operations to calculate or otherwise determine the optimization. For example, based on the original model information, zone optimization may be performed based on the price information, such as the profit, sales information and price image. Calculations done based on the zone optimization may be further refined based on a zone structure strategy, which may include a strategy for including one or more retail locations in defined zones or other strategies, such as maximizing profit or maintaining a price control, for example.

The iterative steps of zone optimization 130 and price optimization 128 provide for optimizing the price zone display. The zone optimization 130 includes the visual interactive component, as described above with respect to FIG. 1. The optimization is based on modeling point of sale historical data, for example what volume of each product in each store is sold and at what price it is being sold. This modeling captures, among other things, how shoppers have reacted to pricing. For each of the zones combination of stores, prices may be optimized and allow for calculating the expected change in profit and sales. Therefore, through the modeling, one can trade off profit and sales changes with the number of zones. By way of example, say that 16 zones give a profit increase of $40 Million per year and 17 zones give a profit increase of $45 Million per year, the stores in each zone can be identified to optimized profit.

In one embodiment, the price zone analysis and optimization objective may be defined globally. A zone structure defining the various regions may be determined at random or otherwise defined by a user or other defined grouping parameters. Price optimization can be performed simultaneously for all stores in one zone. This procedure is done for all zones. The result is global profit, revenue and price image.

Various approaches can be used to group stores into price zones. A first approach is to model all SKUs at the store level and obtain elasticity measures. Filtering of product information may help this procedure. Another approach is to cluster stores into alternative pricing zones and assess the trade-offs between zones. This technique may include comparing optimal profits, business processes and account for various implementation concerns. Another approach may include incorporating limits on pricing business rules used for the modelling operations.

Therefore, the optimization may be accomplished both through various computational operations, but also through the use of an interactive visual interface allowing for the user to manually adjust the zones and thereby view or otherwise monitor the zone adjustment has on the optimization operations.

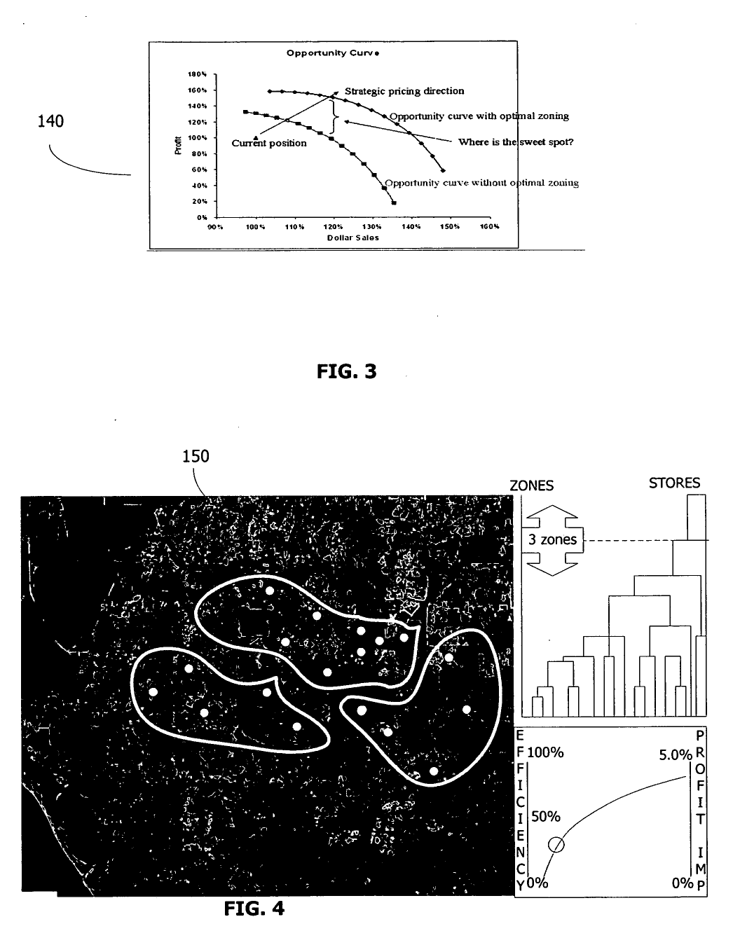

FIG. 3 illustrates a sample opportunity curve 140 that may be used for the iterative analysis to determine the optimization. The opportunity curve 140 includes the mapping of various points of profit relative to dollar sales. This curve 140 includes two different curves, a first curve without optimized pricing and the second curve represents a curve that includes optimized pricing, where the optimized pricing may be performed in accordance with techniques described herein.

The opportunity curve 140 provides a visual representation of data information including a range or gap between the two curves that define the range between a current pricing position and a strategic pricing position. The curve 140 provides the basis for benefit of the iterative process, including finding where the sweet spot, or the profit in relation to sales point that rests between the two curves and fits within the business goals.

FIG. 4 illustrates a sample screen shot of the visualization of the retail locations into specific zones. In one embodiment, the visual interface may be in a two-dimensional or a three-dimensional layer. The screen shot 150 provides a display of the result of a price zone calculation for a given set of parameters. The display 150 includes a geographic map 152 with store locations and zone assignments in the geographic zones. In addition, the display 150 includes a dendogram graph 154 for the parameters in a single screen display.

In the display 150, parameters in the graph 154 may be adjusted interactively, which thereupon provides for recalculation of parameters and adjustment of the groupings in the map display 152, as needed. In the sample screen shot 150, the retail locations are broken down into three zones, where the delineation of the zones may be adjusted and accordingly the efficiency curve similarly adjusts. The interactive nature allows for the manual adjustment of the zones demarcation and a visual display of the efficiency, using efficiency computations in accordance with known computational techniques.

The dendogram graph 154 is a visual display of how the stores are grouped. Starting at the top portion, all the stores are grouped into a single zone and that delineation is adjustable. For example, the double-sided arrow 156 is a slidable graphical element where the arrow, upon being adjusted up or down, adjusts the determination of number of zones. Similarly, the efficiency curve 158 illustrates the corresponding relationship between the adjustment of the number zones with the adjustment of efficiency and profit improvement. As the slider 156 is adjusted, the bubble indicator 159 also moves on the efficiency curve 158. This visual display provides for the interactive adjustment of the zones and the corresponding visual display of the adjustment in efficiency, i.e. how much efficiency is lost with a smaller number of zones.

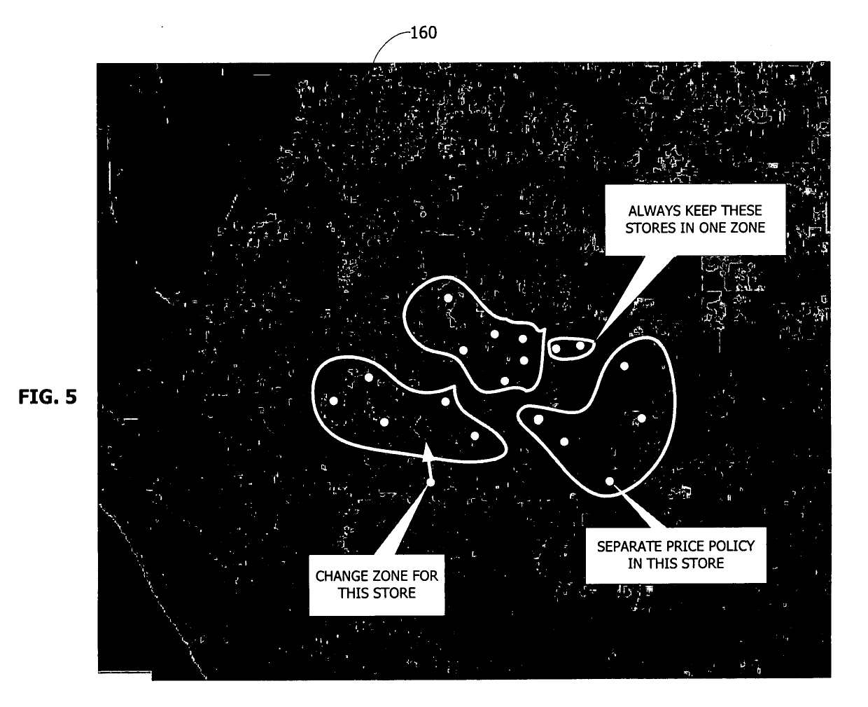

FIG. 5 illustrates another screen shot 160 that includes further iterative operations, including manually modifying the assignment of stores to particular zones. This iterative operation may be provided by graphical user interface allowing for the adjustment of the visual zone lines in the display 160, which may include removing one or more store locations for one group and thereby adding locations to further zones or creating additional zones, as desired.

The screen shot 160 also includes the iterative operation of adding business rules or procedures. For example, one rule may be to always keep two particular retail locations in a specific zone. Another variation may include having different price policies or other attendant parameters for different retail locations in the same zone. The screen shot 160 provides for the iterative operations of the price zone analysis through the graphical interface.

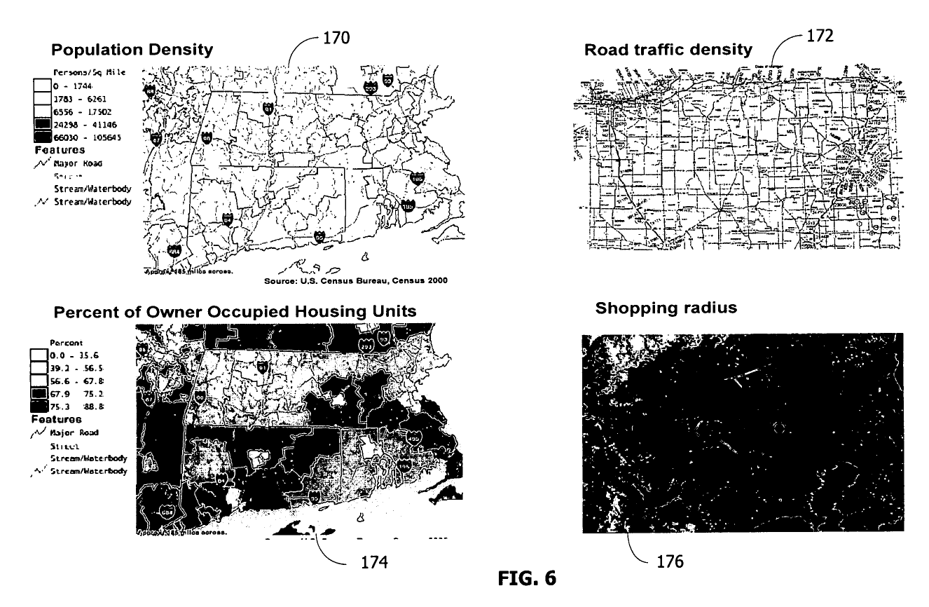

FIG. 6 illustrates four separate sample screen shots 170, 172, 174 and 176. These screen shots include the display of auxiliary information in an overlay relative to the price zone information. This overlay may provide for the superposition of the auxiliary data and can provide for further level of visual analysis. One analysis may include an intuition confirmation through the visual overlay or providing insights to previous known but unrecognized or difficult to solve queries. The overlay provides the overlay of the store zone display, such as the grouping display of FIG. 5, overlaid with one or more types of additional data.

The screen shots of FIG. 6 are exemplary in nature and it is recognized that any other suitable type of auxiliary information may be utilized. In the screen shot 170, population density is provided in a visual overlay on the geographic region and zones. This could provide a visual confirmation of where customers are located relative to retail locations. Screen shot 172 shows road traffic density, which could explain how and how often customers may travel (or not travel due to high traffic conditions) to particular retail locations.

Screen shot 174 shows the sample screen shot of owner occupied housing, which may affect the amount or type of purchasers customers may make, such as for example a person who rents a house or apartment may be less inclined to purchase home remodeling items then a homeowner. In the fourth sample screen shot 176, auxiliary data may include shopping radius information, such as how far a typical customer is willing to travel to perform shopping tasks, where the greater the scarcity of the item, the greater the person may travel and vice versa where the more an item is a commodity, the shorter distance a person is willing to travel and thereby invest further time and money for shopping for said item. It is recognized that any number of suitable types of additional data maybe mapped and provided in a visual overlay as described above.

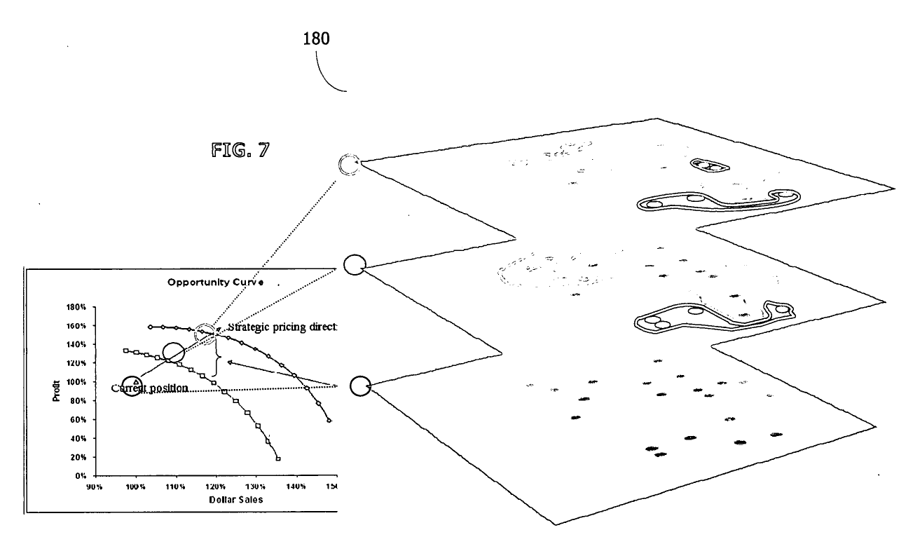

FIG. 7 illustrates additional visual interfaces for price zone information. The display includes 3 flat maps 180, 182 and 184 with the same stores in varying zones. The display may be the result of multiple optimization runs with different parameter sets. The maps 180, 182 and 184 are based off different positions in the opportunity curve 186 offsetting profit with dollar sale increases. At different points in the curves, the maps provide a visual display of the varying zone set-ups. For example, map 180 illustrates all the stores (illustrated as dots on the map) being in their own zone and this correlates to a baseline position on the opportunity curve 186. The map 182 illustrates the selection of a particular zone set-up and how this relates to the opportunity curve. The map 184 shows an additional zoning set-up also having a corresponding position on the opportunity curve 186. Through the inclusion of the different maps, a visual display is provided for the zone of stores relative to the graphical illustration of the modeled information in the opportunity curve 186.

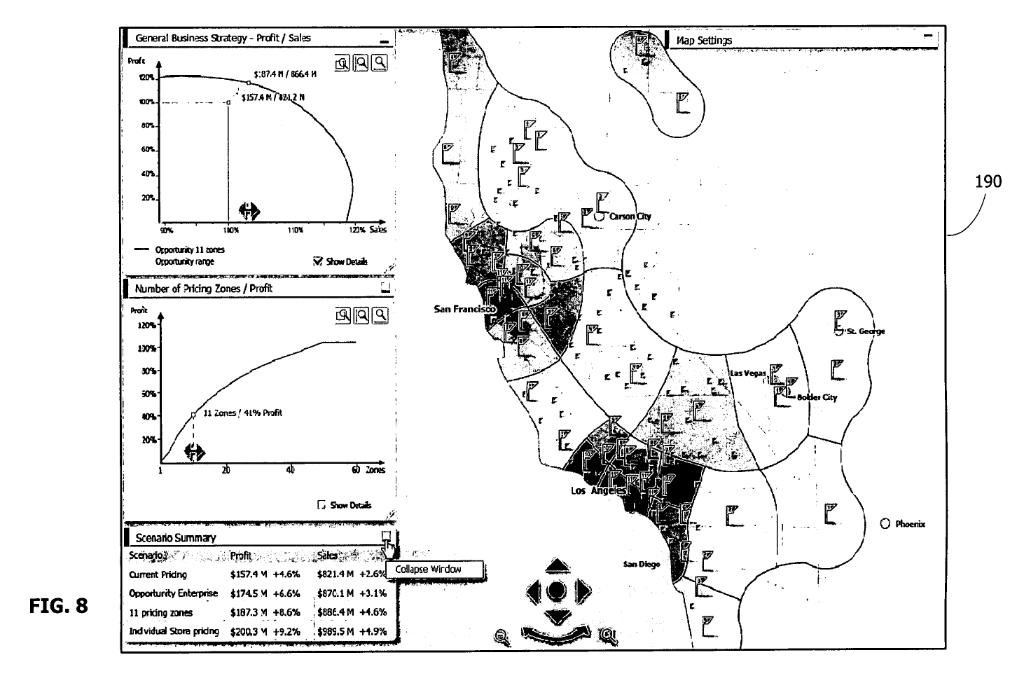

FIG. 8 illustrates another sample screen shot 190 that includes numerous parameter graphs relative to a geographic region map with the various price zones. The display further includes the retail locations, illustrated in this example using three-dimensional flags. The display of the retail locations and the zones are overlaid with a geographic map 191 showing the various counties of the region, which happens to be portions of southwest United States.

In addition, the display 190 includes the profit/sales curve of profit relative to sales operations and the pricing zone/profit curve providing a visual analysis of how the number of zones directly affects profit. For instance, using interactive techniques, a user may adjust a slider on the pricing zone/profit graph 192 and this could additionally adjust the profit/sales graph 194. The data for the graphs 192 and 194 as well as the geographic map 191 are already computed using the above-discussed, as well as some generally known, techniques, therefore the display on the map 191 and the corresponding adjustment of the markers on the graphs 192 and 194 are visually and graphically updated to show the adjustment of the price zoning parameters.

In accordance with techniques described above, the screen shot 190 is operative to user interaction. This interaction may include adjusting various parameters, such as the zones themselves, the factors in the profit/sales curve, the factors in the pricing zone/profit curve, or other additional factors, such as for example that may be adjustable from a pull down menu or other technique allowing a user to enter and thereby adjust such information.

The screen shot 190 may also include additional visual information, such as for example color coding the store icons, number tagging the store icons, drawing zone territories and color coding the territories, among other examples. Other iterative techniques may also include applying a shopping radius around a retail location and the overlapping areas are calculated. Borders may then be drawn between stores from different zones and the areas between the borders are colored. One technique may further include using a Voronoi diagram to determine a border between store areas, and then erase the border between the stores that belong to the same price zone. This technique may also include color-coding the area of the price zone and the for the external area border, using either geographic information (e.g. sea coast) or a shopping radius.

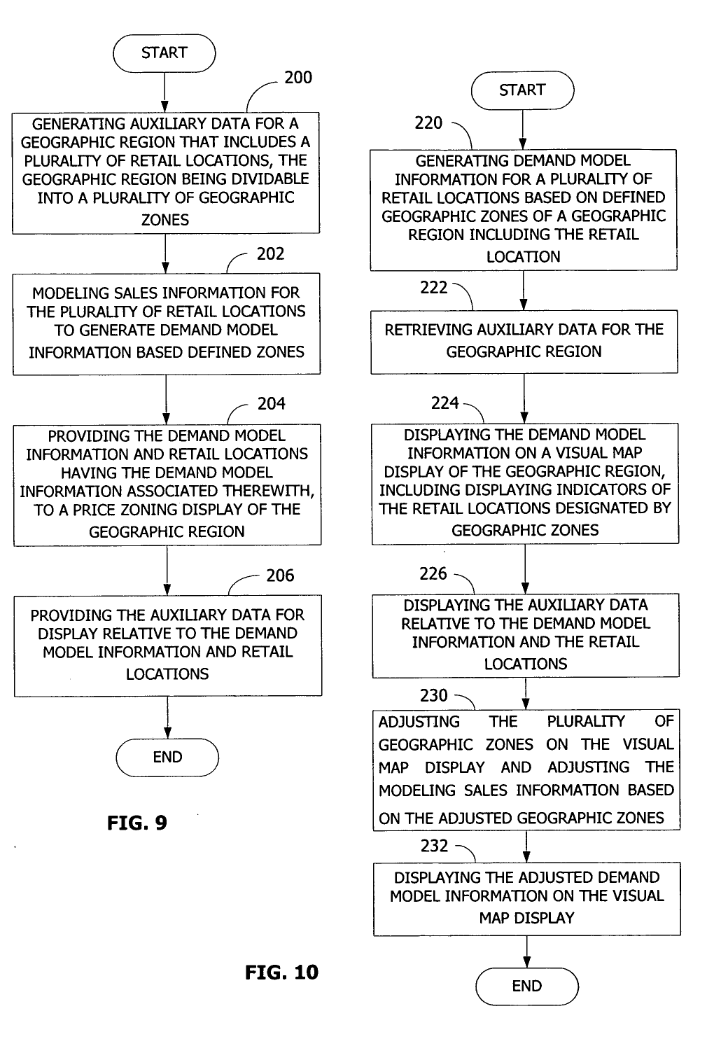

FIG. 9 illustrates the steps of one embodiment of a method for interactive price zone display. In this embodiment, the first step, step 200, is generating auxiliary data for a geographic region that includes a plurality of retail locations, the geographic region being dividable into a plurality of geographic zones. As described above with respect to FIG. 1, this may include retrieving data from an auxiliary database or receiving information from any other suitable source, where the auxiliary data provides information outside of the retail information used in the modeling operations.

The next step, step 202, is modeling the sales information for the plurality of retail locations to generate demand model information based on defines zones. This operation may be performed in accordance with known modeling techniques or operations. The next step, step 204, is providing the demand model information and retail locations having the demand model information associated therewith to a price zoning display of the geographic region. The display of model information may include graphical information, such as the graphs of information provided in several of the sample screenshots above.

The next step, step 206, is providing the auxiliary data for display relative to the demand model information and retail locations. This data may be formatted and made available for display on an output display device, such as display device 112 of FIG. 1, providing a visual indication of the auxiliary data in relation to the display of retail locations on the geographic region and zone divisions.

In additional embodiments, further steps may be performed for interactive price zone display. An additional step may include adjusting the plurality of geographic zones in the price zone display and thereby adjusting the modeling sales information based on the adjusted geographic zones. The adjustment of modeling information, similar to step 202 above, may be performed using known modeling techniques and/or operations.

Additionally, another step may be providing the adjusted demand model information for display relative to the auxiliary data on the price zone display. Another embodiment may further include generating one or more graphical display comparison of modeling input factors and displaying the graphical display of the modeling factors relative to the display of the geographic zone. This is illustrated in the graphical displays of screenshots of FIGS. 7 and 8.

FIG. 10 illustrates the steps of one embodiment of a method for iterative price zone analysis. The steps of the method may also be performed by one or more processing devices in response to executable instructions. The first step, step 220, includes generating demand model information for a plurality of retail locations based on defined geographic zones of a geographic region including the retail location. The next step, step 222, is retrieving auxiliary data for the geographic region.

Step 224 includes displaying the demand model information on a visual map display of the geographic region, including displaying indicators of retail locations designated by geographic zones. The display of the demand model information may include the display of the graphical comparison of various price zone factors.

Step 226 includes displaying the auxiliary data relative to the demand model information and the retail locations. Such as illustrated in the sample screen shots 170, 172, 174 and 176 of FIG. 6, the auxiliary data may be overlaid with display of retail locations. In another example, the screen shot 190 of FIG. 8 includes the auxiliary data of state and county information that is overlaid with the retail location information and the demand modeling information.

The next step 230 includes adjusting the plurality of geographic zones on the visual map display and adjusting the modeling sales information based on the adjusted geographic zones. The adjustment of geographic zones may include the manual or physical adjustment of zones. Additionally, the adjustment of zones may also include adjusting rules or other factors that define the zones, such as discussed above and illustrated in the screen shot 160 of FIG. 5.

In this embodiment, the next step, step 232, is displaying the adjust demand model information on the visual map display. This step provides for the iterative user interaction of price zone information through the visual interface. The iterative operations and repetition of various steps of this method provides the price zone optimization using the visual interface and graphical interface for user interaction. Thereupon, in this embodiment, the method is complete.

Therefore, price zone optimization may be performed using a visual interactive technique. This optimization is further optimized by the inclusion of auxiliary data in a visual graphical user display to allow for the manual adjustment of various modeling factors or zone factors and thereby adjust the modeling operations. The display of the price zone information as well as the retail location and overlay of auxiliary information provides an added dimension of information to otherwise static pricing and other economic retail information. Additionally, the visual inclusion of the auxiliary information allows for the validation of mental reasoning techniques or intuitive analysis relative to concrete auxiliary data that was previously unavailable from the non-visual modeling systems.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An interactive price zoning display method comprising:
generating auxiliary data for a geographic region that includes a plurality of retail locations, the geographic region being dividable into a plurality of geographic zones;
modeling sales information for the plurality of retail locations to generate demand model information based defined zones;
providing the demand model information and retail locations having the demand model information associated therewith, to a price zoning display of the geographic region; and
providing the auxiliary data for display relative to the demand model information and retail locations.

2. The method of claim 1 further comprising:
adjusting the plurality of geographic zones on the price zoning display; and
adjusting the modeling sales information based on the adjusted geographic zones.

3. The method of claim 2 further comprising:
providing the adjusted demand model information for display relative to the auxiliary data on the price zoning display.

4. The method of claim 3 further comprising:
generating at least one graphical display of a comparison of modeling factors; and
displaying the at least one graphical display adjacent to the map display.

5. The method of claim 1 further comprising:
providing at least one of: two dimensional graphical elements or three dimensional graphical elements for the display of the retail locations on the map display.

6. The method of claim 1 further comprising:
providing color-coding display information for each of the geographic zones on the price zoning display.

7. The method of claim 1 wherein the auxiliary data is displayed in an overlaid position relative to the demand model information and retail locations.

8. An interactive price zoning display apparatus comprising:
a memory device having executable instructions stored therein; and
a processing device, in response to the executable instructions, operative to:
generate auxiliary data for a geographic region area that includes a plurality of retail locations, the geographic region being dividable into a plurality of geographic zones;
model sales information for the plurality of retail locations to generate demand model information based defined zones;
provide the demand model information and retail locations having the demand model information associated therewith, to a price zoning display of the geographic region; and
provide the auxiliary data for display relative to the demand model information and retail locations.

9. The apparatus of claim 8, wherein the processing device is further operative to:
adjust the plurality of geographic zones on the price zoning display; and
adjust the modeling sales information based on the adjusted geographic zones.

10. The apparatus of claim 8, wherein the processing device is further operative to providing the adjusted demand model information for display relative to the auxiliary data on the price zoning display.

11. The apparatus of claim 10, wherein the processing device is further operative to:
generate at least one graphical display of a comparison of modeling factors; and
display the at least one graphical display adjacent to the map display.

12. The apparatus of claim 8, wherein the processing device is further operative to provide at least one of: two dimensional graphical elements or three dimensional graphical elements for the display of the retail locations on the map display.

13. The apparatus of claim 8, wherein the processing device is further operative to provide color-coding display information for each of the geographic zones on the price zoning display.

14. A method for iterative price zone analysis, the method comprising:
generating demand model information for a plurality of retail locations based on defined geographic zones of a geographic region including the retail locations;
retrieving auxiliary data for the geographic region;
displaying the demand model information on a visual map display of the geographic region, including displaying indicators of the retail locations designated by geographic zones;
displaying the auxiliary data relative to the demand model information and the retail locations;
adjusting the plurality of geographic zones on the visual map display;
adjusting the modeling sales information based on the adjusted geographic zones; and
displaying the adjusted demand model information on the visual map display.

15. The method of claims 14 further comprising:
generating at least one graphical display of a comparison of modeling factors; and
displaying the at least one graphical display adjacent to the map display.

16. The method of claim 14 wherein the retail location indicates are at least one of: two-dimensional graphical elements or three-dimensional graphical.

17. The method of claim 14 further comprising:
color-coding the display information for each of the geographic zones on the price zoning display.

18. The method of claim 14 wherein the auxiliary data is displayed in an overlaid position relative to the demand model information and retail locations.

19. A system for iterative price zone analysis, the system comprising:
a display device operative to provide a visual display;
an input device operative to receive an input command;
a memory device having executable instructions stored therein; and
a processing device coupled to the display device and the input device, in response to the executable instructions, operative to:
generate demand model information for a plurality of retail locations based on defined geographic zones of a geographic region including the retail locations;
retrieve auxiliary data for the geographic region;
display the demand model information on a visual map display of the geographic region, including displaying indicators of the retail locations designated by geographic zones on the display device;
displaying the auxiliary data relative to the demand model information and the retail locations on the display device;
adjusting the plurality of geographic zones on the visual map display;
adjusting the modeling sales information based on the adjusted geographic zones; and
displaying the adjusted demand model information on the visual map display on the display device.

19. The apparatus of claim 18, the processing device further operative to:
generate at least one graphical display of a comparison of modeling factors; and
display the at least one graphical display adjacent to the map display.

20. The apparatus of claim 18 wherein the retail location indicators are displayed as at least one of: two dimensional graphical elements or three dimensional graphical.

21. The apparatus of claim 18, the processing device further operative to color-code the display information for each of the geographic zones on the price zoning display visible on the display device.
